(19) United States
(12) Patent Application Publication
(10) Pub. No.: US 2017/0031467 A1
(43) Pub. Date: Feb. 2, 2017

(54) METHOD, ACCESSORY AND TOUCH WRITING PEN FOR SIMULTANEOUSLY FORMING ENTITY AND ELECTRONIC HANDWRITING

(71) Applicant: Coretronic Corporation, Hsin-Chu (TW)

(72) Inventors: Pen-Ning Kuo, Hsin-Chu (TW); Chung-Lung Yang, Hsin-Chu (TW); Kun-Rong Chang, Hsin-Chu (TW)

(21) Appl. No.: 15/148,196

(22) Filed: May 6, 2016

(30) Foreign Application Priority Data
Jul. 29, 2015 (TW) 104124603

(51) Int. Cl. G06F 3/0354; G06F 3/038

(52) U.S. Cl. CPC G06F 3/03545; G06F 3/0383

(57) ABSTRACT

A touch input accessory for being mounted onto a writing device includes a sleeve portion for being inserted therein a portion of the penholder at the end having the writing tip; a conductive touch head, made of a conductive material, connected to the sleeve portion, and including an opening so that when the sleeve portion is sleeved onto the penholder, the writing tip is enveloped by the conductive touch head, and the nib of the writing tip is protruded from the opening; and a contact conductive portion disposed on the sleeve portion and electrically connected to the conductive touch head, so that when a user holds the writing device and contacts the contact conductive portion to form an entity handwriting on the writing surface, the conductive touch head simultaneously contacts the writing surface to form a corresponding electronic handwriting.

### CROSS-REFERENCE TO RELATED APPLICATION

This application claims the priority benefit of Taiwan application serial no. 104124603, filed on Jul. 29, 2015. The entirety of the above-mentioned patent application is hereby incorporated by reference herein and made a part of this specification.

### FIELD OF THE INVENTION

The invention relates to a method and apparatus for touch input, and more particularly to a method and apparatus integrating touch input and handwriting functions.

### BACKGROUND OF THE INVENTION

In recent years, the development of touch-input technology is in the ascendant, and the application field becomes wider every day. In addition to the conventional touch input panel, smart phones and other applications, the application field of touch-input technology has been expanded to be combined with the traditional writing mediums such as the whiteboard, etc. As shown in FIG. 1, a touch writing system 10 includes a touch input device 11, an input device 12, a computer device 13 and other components. Among them, the touch input device 11, different from keyboards, mice and other general input devices 12, might be a projected capacitive touch (PCT) display device, a projected capacitive touch screen with the projector's projection system, or a projected capacitive touch whiteboard, and other similar devices, and is connected to the computer device 13 such as a personal computer, a laptop or other computer devices capable of generating images and receiving user-input information. Touch input means 11 includes a writing surface 111, and thus is possible to have both touch-input and handwriting functions. In terms of touch input, the user delivers a message to the computer input device 13 through the stylus 14 or the user's finger 15 or other input devices, and the input information is stored or displayed through the screen, projectors and other displays and thus achieves an interactive effect. Handwriting entity may be separately written down on the writing surface 111 of the touch input means 11 through the writing means 16, such as a whiteboard pen, etc., and no more other electronic device is needed.

At present, active or passive stylus may only work with capacitive touch sensing plane means. The handwriting made by the stylus may only be shown through the monitor or projector, and cannot being displayed in an ink way as that done by a general whiteboard pen.

The information disclosed in this “BACKGROUND OF THE INVENTION” Section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### SUMMARY OF THE INVENTION

There is no stylus or ink whiteboard pen along with both the entity ink (ink whiteboard pen) and electronic ink (active and passive touch pen) functions. Therefore, different input tools must be provided separately for the handwriting/touch-input functions, and operations of the two functions cannot be performed simultaneously, which is very inconvenient.

An object of the invention is to solve the aforementioned problems by using of a simple structure improvement or accessory to form entity handwriting and electronic handwriting simultaneously on a writing surface.

Another object of the invention is to provide an accessory to the current whiteboard pen products, so that an ink whiteboard pen on the market can function simultaneously with PCT products on entering the touch input, but also to maintain the original handwriting function.

A further object of the invention is to make the current stylus, whether active or passive, with new features simultaneous touch and writing.

A still further object of the invention is to develop a method for simultaneously generating and erasing the entity and electronic handwritings, and the associated apparatus to implement the method.

Other advantages and objects of the invention may be further illustrated by the technical features broadly embodied and described as follows.

In order to achieve one or a portion of or all of the objects or other objects, an embodiment of the invention provides a touch input accessory for being mounted onto a writing device, wherein the writing device includes a penholder and a writing tip having a nib and disposed at one end of the penholder, which is capable of writing on a writing surface having a touch input function. The touch input accessory includes a sleeve portion, one end of which has a mount opening for being inserted therein a portion of the penholder at the end having the writing tip, so that the penholder is sleeved by the sleeve portion; a conductive touch head, made of a conductive material, connected to the sleeve portion. and the conductive touch head includes an opening so that when the sleeve portion is sleeved onto the penholder, the writing tip is enveloped by the conductive touch head, and the nib of the writing tip is protruded from the opening; and a contact conductive portion disposed on the sleeve portion and electrically connected to the conductive touch head, so that when a user holds the writing device and contacts the contact conductive portion to form an entity handwriting on the writing surface, the conductive touch head simultaneously contacts the writing surface to form a corresponding electronic handwriting.

The invention also provides a touch writing pen for writing on a writing surface having a touch input function. The touch writing pen includes a penholder, a writing tip mounted on one end of the penholder, a conductive touch head disposed at the surrounding of the writing tip, and a contact conductive portion attached to the penholder and electrically connected to the conductive touch head. The conductive touch head has an opening, so that the writing tip is capable of being exposed in a situation that both the pen tip and the conductive touch head contact the writing surface simultaneously.

The invention also provides a wiping device capable of erasing an entity handwriting written by a touch writing pen on a writing surface with a touch input function, and an electronic handwriting corresponding to the entity handwriting. The touch writing pen includes a penholder, a writing tip mounted on one end of the penholder, a conductive touch head disposed at the surrounding of the writing tip, and a contact conductive portion attached to the penholder and electrically connected to the conductive touch head. The pen tip and the conductive touch head are capable of contacting the writing surface simultaneously. The wiping device includes a main body, a conductive wiping surface disposed at one side of the main body, and a conductive element electrically connected to the wiping surface, so that the wiping surface is capable of erasing the entity handwriting and the corresponding electronic handwriting simultaneously.

The invention also provides a method for simultaneously forming an entity handwriting and a corresponding electronic handwriting. The method includes steps of transferring via a touch writing pen a writing material to a writing surface of a touch input device to form the entity handwriting, wherein the touch writing pen includes a writing tip; and, at the same time, providing a conductive means surrounding the writing tip, and forming an electronic conductive path between the writing surface and a user's body through the conductive means in order to perform a touch input so as to form the electronic handwriting.

Other objectives, features and advantages of the invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The invention will become more readily apparent to those ordinarily skilled in the art after reviewing the following detailed description and accompanying drawings, in which:

FIG. 1 is a schematic view of a conventional touch writing systems architecture.

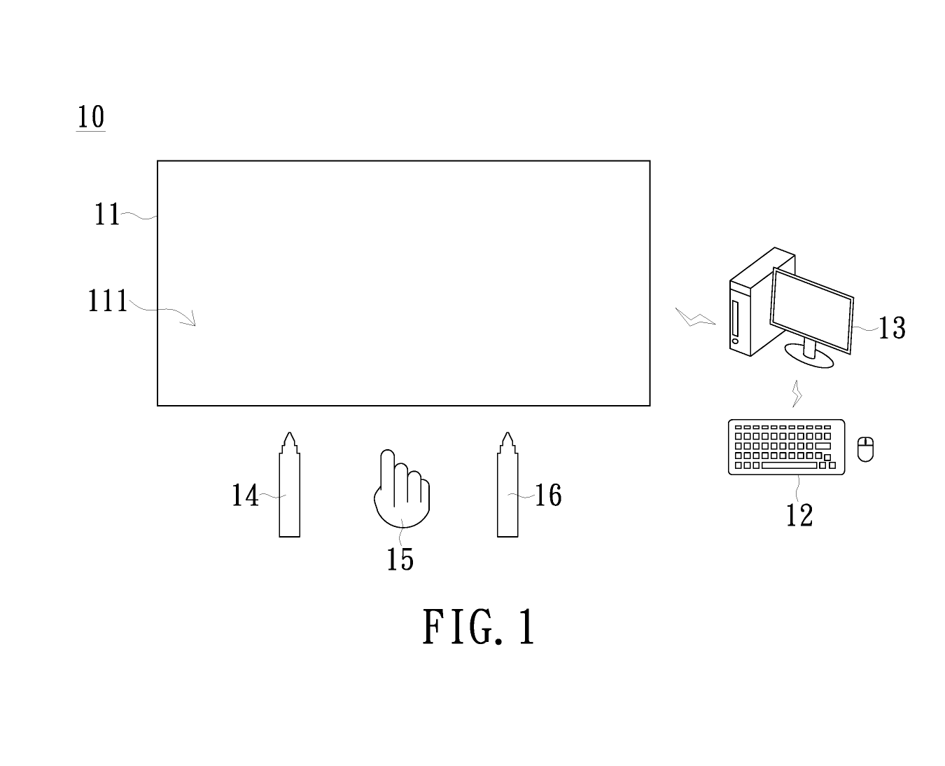

FIG. 2A is a schematic cross-sectional view of a touch input accessory capped on a writing device in accordance with an embodiment of the invention.

FIG. 2B is a schematic cross-sectional view of a touch input accessory capped on a writing device in accordance with another embodiment of the invention.

FIG. 2C is a schematic cross-sectional view of a touch writing pen in accordance with an embodiment of the invention.

FIG. 2D is a schematic cross-sectional view of a touch writing pen in accordance with another embodiment of the invention.

FIG. 3 is a touch writing system architecture diagram illustrating the application of a touch input accessory in accordance with an embodiment of the invention.

FIG. 4 is a schematic diagram illustrating an operation of the touch input accessory applied in a touch writing system in accordance with an embodiment of the invention.

FIG. 5 is a schematic diagram illustrating an operation of the wiping means used in the touch writing system in accordance with an embodiment of the invention.

FIG. 6 is a schematic structural view of the wiping means in accordance with an embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

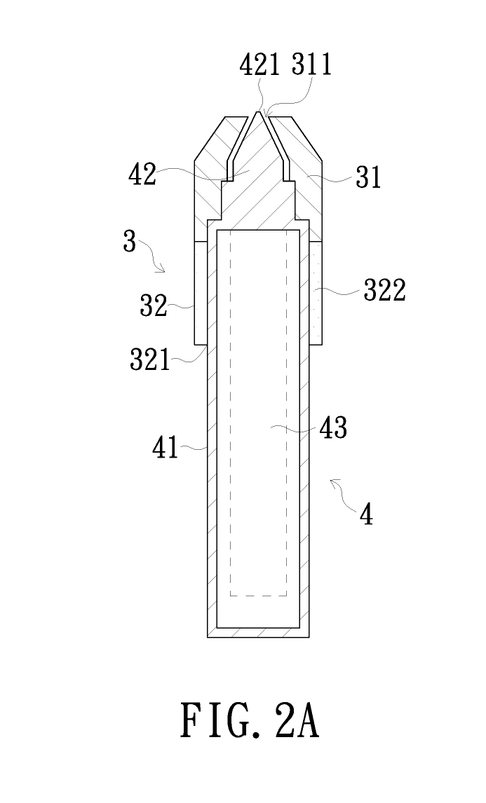

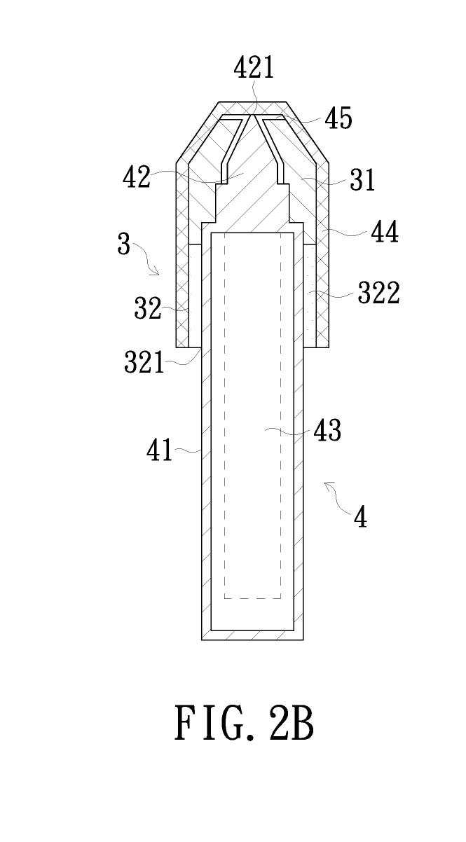

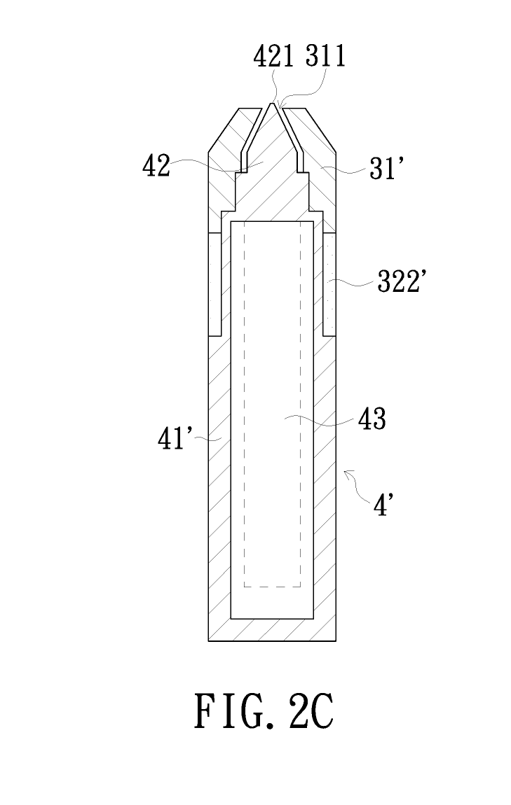

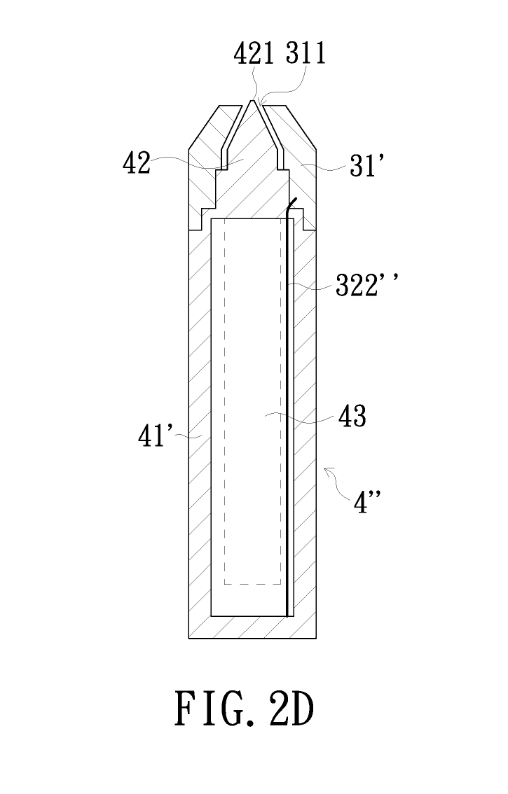

Referring to FIG. 2A, a touch input accessory 3 is composed by a conductive touch head 31 and a sleeve portion 32 connecting to the conductive touch head 31. The sleeve portion 32 is a hollow ring or a tubular structure. The sleeve portion 32 has a mount opening 321 formed on one end thereof for being mounted on a writing device 4. The conductive touch head 31 is located at another end of the sleeve portion 32, which is opposite to the mount opening 321. The writing device 4 includes a penholder 41 and a writing tip 42 connecting to one end of the penholder 42, and a portion of the penholder 41 with the writing tip 42 is capable of being inserted into the sleeve portion 32 of the touch input accessory 3 through the mount opening 321, so that the penholder 41 is sleeved by the sleeve portion 32. The conductive touch head 31 is a hollow structure and is made of a conductive elastic material. The sleeve portion 32 is attached to a connecting end of the conductive touch head 31. There is an opening 311 formed on a contacting end of the conductive touch head 31. The contacting end of the conductive touch head 31 is opposite to the connecting end of the conductive touch head 31. The opening 311 is communicated with the hollow structure of the conductive touch head 3, so that when the sleeve portion 32 of the touch input accessory 3 is sleeved onto the penholder 41 of the writing device 4, the conductive touch head 31 envelops most of the writing tip 42, and only a nib 421 of the writing tip 42 is protruded from the conductive touch opening 311. The touch input accessory 3 includes a contact conductive portion 322. The contact conductive portion 322 is disposed on the sleeve portion 32, which is electrically connected to the conductive touch head 31. The sleeve portion 32 and the conductive touch head 31 may be formed separately, or integrally formed on the same element. For example, the sleeve portion 32 and the conductive touch head 31 may be respectively located at two opposite ends of a hollow conductive rubber ring (or a hollow conductive rubber tube), or the sleeve portion 32 and the conductive touch head 31 are integrally together to form a hollow conductive rubber ring (or a hollow conductive rubber tube). A diameter of the conductive touch opening 311 of the conductive touch head 31 may be smaller than a diameter of the sleeve portion 32, such that the position of the penholder 41 is limited within the sleeve portion 32 and the nib 421 is protruded from the conductive touch opening 311.

In the embodiment shown in FIG. 2A, the sleeve portion 32 and the contact conductive portion 322 are the same site of the aforementioned hollow conductive rubber ring, while in other embodiments, the sleeve portion 32 and the contact conductive portion 322 can also be produced separately, and then the sleeve portion 32 is not necessarily made of a conductive material, and the contact conductive portion 322 disposed on the sleeve portion 32 may be a metal wire secured to the sleeve portion 32; one end of the metal wire (the contact conductive portion 322) is electrically connected to the conductive touch head 31, and the other end is connected to the other parts of the configuration to the penholder 41. However, it is not to limit the scope of the invention.

The penholder 41 may receive at least one cartridge (not numbered) within it, and the writing tip 42 may be connected to written material 43 filled in the aforesaid cartridge. For example, when the writing material 43 filled within the cartridge is some kind of ink, then the writing tip 42 may be an ink writing tip for forming an ink entity handwriting.

Referring to FIG. 2B, in this embodiment, the writing device 4 may further include a pen cap 44. The pen cap 44 is capped onto the touch input accessory 3 and covers the conductive touch head 31 when the writing device 4 is in a non-writing state, such that the writing tip 42 is maintained in an enclosed space 45 to prevent the writing material 43, e.g. ink, from being easily dried up. The pen cap 44 may fit tightly at the other end of the penholder 41, so as to prevent being lost when being separated from the end of the writing tip 42 during a writing state of the writing device 4. Except ink, the writing material 43 may also be other substances, such as graphite, which may generate entity handwriting. That is, the writing tip 42 may also a graphite (pencil) tip or other kinds of writing tips, but it is not to limit the scope of the invention.

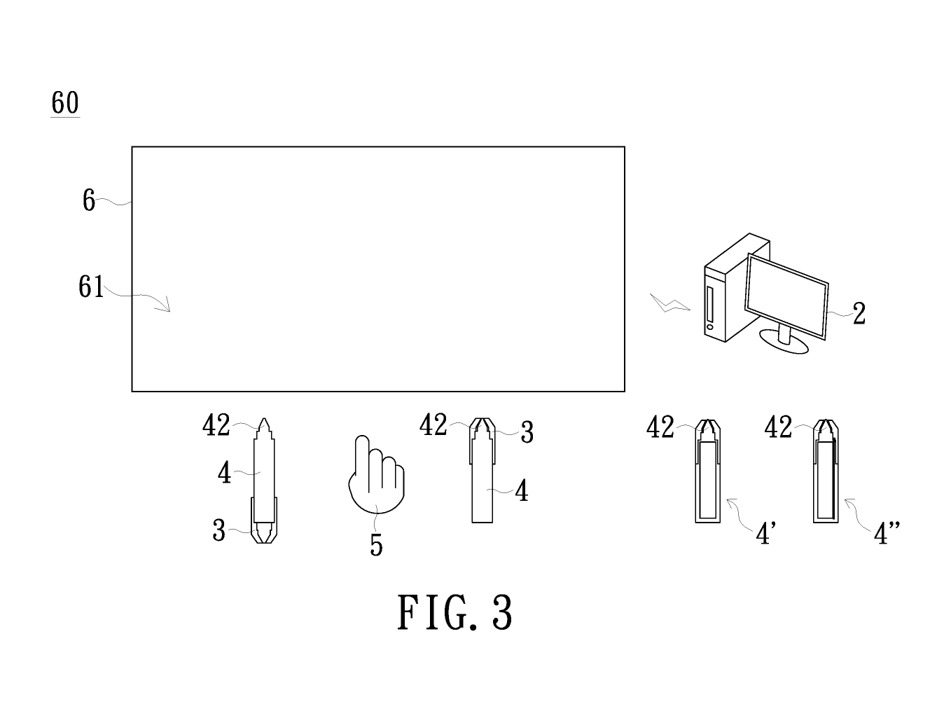

Another embodiment is shown in FIG. 2C. The touch input accessory 3 of the invention may also be directly integrated with the writing device 4, and thus forms a touch writing pen 4′. The touch writing pen 4′ includes a penholder 41′, the writing tip 42 attached to one end of the penholder 41′, a conductive touch head 31′ disposed at the surrounding of the writing tip 42, and a contact conductive portion 322′ disposed on the penholder 41′ and electrically connected to the conductive touch head 31′. The contact conductive portion 322′ in the embodiment may be an electrically conductive annular or tubular article, and is exposed to the outside of the penholder 41′. However, it is not to limit the scope of the invention. Wherein, the conductive touch head 31′ has an opening 311, so that the nib 421 of the writing tip 42 may be exposed in a situation that both the nib 421 and the conductive touch head 31′ contact the writing surface (not shown) simultaneously. The touch writing pen 4′ operated with a touch-input function may be a simple passive stylus, or a active stylus capable of communicating with the touch writing system 60 (refer to FIG. 3), so that the touch writing system 60 is able to identify which active stylus is operated so as to correspondingly generate electronic handwriting of the active stylus (as the electronic handwriting shown in FIG. 7B).

FIG. 2D is a cross-sectional view of another embodiment of the touch writing pen according to the invention. In the embodiment, the touch writing pen 4″ illustrated in FIG. 2D is similar to the touch writing pen 4′ shown in FIG. 2C, but there are differences which will be described below. As shown in FIG. 2D, the contact conductive portion 322″ of the touch writing pen 4″ is a conductive long strip or wire object, e.g. a conductive metal sheet or metal wire. The contact conductive portion 322″ may be installed within the penholder 41′ of the touch writing pen 4″. One end of the contact conductive portion 322″ is electrically connected to the conductive touch head 31′, and the other end of the contact conductive portion 322″ is housed within the penholder 41′ and is extended to the middle portion or the end of the penholder 41′, in order to effectively achieve the discharge function.

The aforementioned touch input accessory 3, the touch writing pen 4′, or the touch writing pen 4″ may be applied in the touch writing system 60 illustrated in FIG. 3. Please refer to FIGS. 2A, 2C, 2D, and 3, the touch writing system 60 is constructed by the touch input device 6 and a computer device 2 or the like. The touch input device 6 capable of displaying images may be a projected capacitive touch (PCT) display means, a projection system having a PCT screen and a projector, a PCT whiteboard device, etc., and is connected to a personal computer, laptop or other computer device 2 which is capable of generating image data and receiving user input information. The touch input device 6 includes a writing surface 61, so that there might be both touch input and handwriting functions. The user may deliver an input message to the computer device 2 by contacting the writing surface 61 through the touch input accessory 3, the touch writing pen 4′, the touch writing pen 4″, or the user's finger 5, etc., for storing the input information within the computer device 2. The computer device 2 may optionally respond with corresponding message through the display device, projector, etc. (might be a component contained by the touch input device 6 itself, or an additional equipment), and achieve interactive effect. The writing surface 61 of the touch input device 6 may be directly written by the writing device 4, e.g. a whiteboard pen, which may leave the entity handwriting (ink handwriting) on the writing surface 61. The transparency of the writing surface 61 may be varied for the need of various applications. For example, if the touch input device 6 is a projected capacitive touch display device, the writing surface 61 needs to be transparent. And, when the touch input device 6 is a projected capacitive touch screen used with a projection system, or a projected capacitive touch whiteboard, the writing surface 61 may have a color suitable for needs of different applications, such as white or silver, and so on.

Referring again to FIG. 3, the touch input accessory 3 may be used in two operation modes, one of them is illustrated in FIG. 2A, the touch input accessory 3 is sleeved on one end of the penholder 41, and thus the writing device 4 and the touch input accessory 3 contact the writing surface 61 to form both entity and electronic handwritings simultaneously. In the other operation mode, the touch input accessory 3 is sleeved on the other end of the penholder 41 which has no writing tip 42, so that the touch function and writing function will be separated. When using the writing tip 42 to contact the writing surface 61, only entity handwriting is formed; conversely, when it is needed to use the touch function, the user just has to reverse the writing device 4 and hold the touch input accessory 3 by fingers. Thus, the diversity of operation modes is increased, and it is possible to choose suitable mode in different application requirements to facilitate the operation. As shown in FIGS. 2C, 2D and 3, when the touch writing pen 4′, 4″ is operated, the writing tip 42 and the conductive touch head 31′ contact the writing surface 61 to form both entity and electronic handwritings simultaneously.

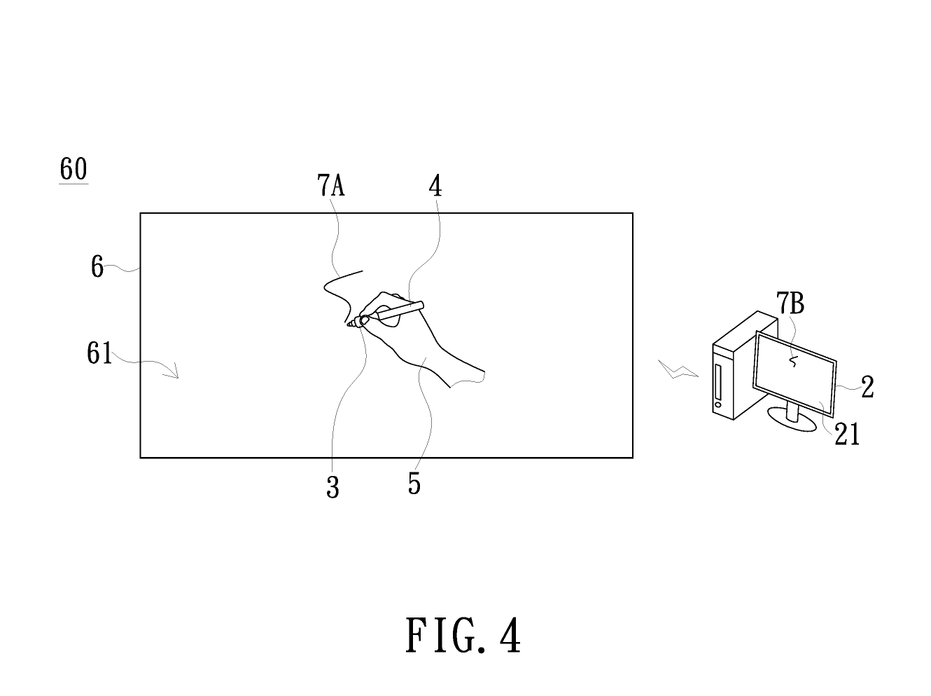

As shown in FIG. 4, when user holds the writing device 4 sleeved by the touch input accessory 3 and contacts with the conductive portion 322 (as shown in FIG. 2A) by user's body 5 (e.g. hand) to execute a handwriting input on the writing surface 61, the writing material 43 is transferred through the writing tip 42 to the writing surface 61 and the entity handwriting 7A is correspondingly formed on the writing surface 61. At the same time, the touch input accessory 3 also contacts the writing surface 61 of the touch input device 6 by its conductive touch head (not numbered), and an electronic conductive path is produced between the writing surface 61 and the user's body 5, and so it is possible to simultaneously execute a touch input, and the electronic handwriting 7B corresponding to the entity handwriting 7A is formed, transferred and stored in the computer system 2. Optionally, the electronic handwriting 7B may also be displayed on a display 21 of the computer system 2. In addition, the user can hold the touch writing pen 4′ shown in FIG. 2C to contact with the contact conductive portion 322′ by the hand, or the user may use the touch writing pen 4″ shown in FIG. 2D, and does not need to contact the contact conductive portion 322″, such that the handwriting input and the touch input can be simultaneously reached. In addition to using the aforementioned touch input accessory 3, the touch writing pen 4′ or the touch writing pen 4″, the electronic conductive path between the writing surface 61 and the user's body 5 can also be produced in any other form of conductive material or any other conductive means, disposed surrounding the writing tip 42, and extending to the user's body 5, in order to reach a result as a human body's direct touch, or to form an electronic conductive path between the touch writing pen and the writing surface by other designs.

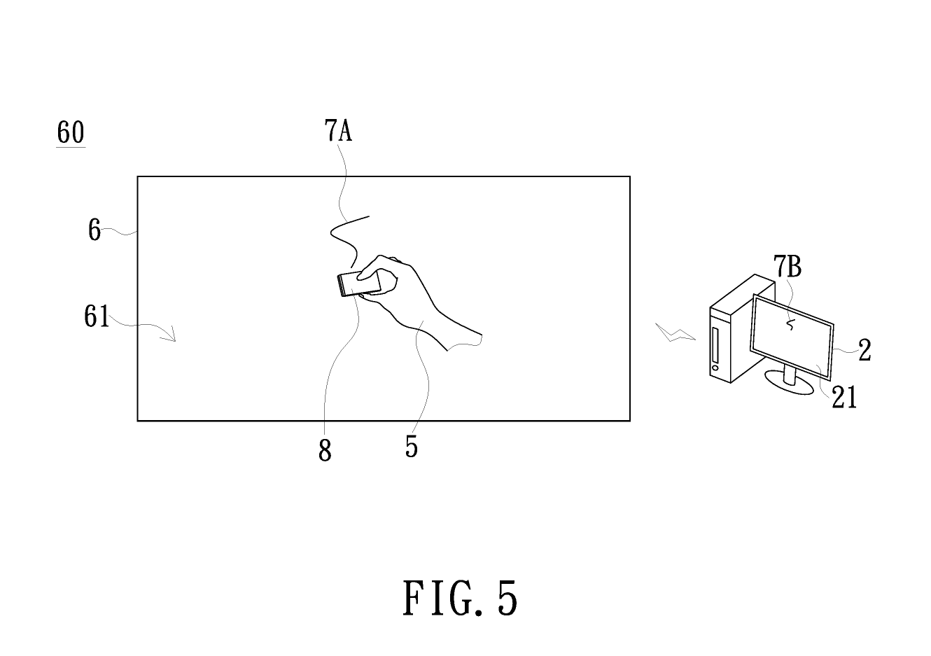

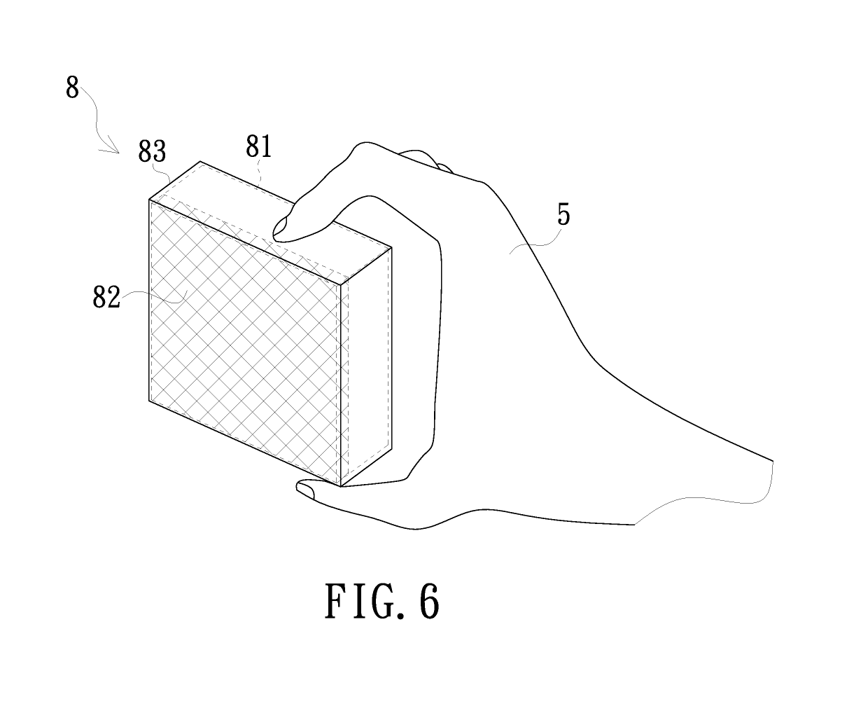

Referring to FIGS. 5 and 6, to simultaneously erasing the entity handwriting 7A and the electronic handwriting 7B, a specific area value T is preset. When any conductive object contacts the writing surface 61 of the touch input device 6, and the contact area of the conductive object is larger than the specific area value T, it will be determined by the touch writing system 60 a wiping operation to the electronic handwriting. To achieve this purpose, there is provided a wiping device 8, which includes a main body 81, having a wiping surface 82 with a conductive area greater than the specific area value T, and a conductive element 83 electrically connected to the wiping surface 82 of the main body 81. The wiping surface 82 may be covered by a sheet of conductive fiber cloth, or other conductive material, capable of erasing the entity handwriting. The wiping surface 82 having the conductive area contacts with the writing surface 61, and the conductive area is greater than the specific area value T. The conductive element 83 may be conductive tape winding around the edge of the wiping surface 82 of the main body 81, and, without affecting the value of the conductive area in contact with the writing surface 61, the conductive element 83 may be other forms of conductive structures disposed on the wiping device 8. When executing the wiping operation, the user holds the whole or part of the conductive element 83, which causes the body 5 of the user electrically connected to the wiping surface 82 of the main body 81 through the conductive element 83. The entity handwriting 7A is directly erased by the wiping surface 82 of the main body 81. At the same time, it is detected by the touch writing systems 60 a conductive contact between the wiping device 8 and the writing surface 61 with the contact area greater than the specific area value T. Accordingly, the wiping operation to the electronic handwriting 7B is determined. Therefore, the entity handwriting 7A and the corresponding electronic handwriting 7B are erased simultaneously.

To sum up, the invention provides touch input accessories or integral touch writing pens to enable the conductive touch head and the writing tip contacting the writing surface simultaneously, so as to develop a new function of generating/erasing the entity and electric handwritings simultaneously, so that an touch input on a PCT whiteboard can be done by a general whiteboard pen, and a touch writing pen is enabled to generate entity handwriting during an input operation of an electrical handwriting. The aforementioned functions can be performed by providing an accessory with simple structure, and is easy and diversified in operation. The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A touch input accessory for being mounted onto a writing device, wherein the writing device includes a penholder and a writing tip having a nib and disposed at one end of the penholder, which is capable of writing on a writing surface having a touch input function, the touch input accessory includes:
a sleeve portion having a mount opening, a portion of the penholder with the writing tip being inserted therein;
a conductive touch head, made of a conductive material, connected to the sleeve portion and including an opening so that when the sleeve portion is sleeved onto the penholder, the writing tip is enveloped by the conductive touch head, and the nib of the writing tip is protruded from the opening; and
a contact conductive portion disposed on the sleeve portion and electrically connected to the conductive touch head, so that when a user holds the writing device and contacts the contact conductive portion of the touch input accessory to form an entity handwriting on the writing surface, the conductive touch head simultaneously contacts the writing surface to form a corresponding electronic handwriting.

2. The touch input accessory according to claim 1, wherein the writing tip is an ink writing tip, and the entity handwriting is an ink handwriting.

3. The touch input accessory according to claim 2, wherein the writing surface is a writing surface of an electronic whiteboard.

4. The touch input accessory according to claim 3, wherein the electronic whiteboard is a projected capacitive touch whiteboard.

5. The touch input accessory according to claim 2, further comprising a pen cap capped onto the touch input accessory for covering the conductive touch head, such that the writing tip is maintained in an enclosed space to prevent a writing material within the writing device from being dried up.

6. The touch input accessory according to claim 1, wherein the sleeve portion and the conductive touch head are constructed by a hollow conductive rubber ring having two opposite ends , and the sleeve portion and the conductive touch head are respectively disposed at the two ends of the hollow conductive rubber ring.

7. A touch writing pen for writing on a writing surface having a touch input function, comprising a penholder, a writing tip disposed on an end of the penholder, a conductive touch head disposed at the surrounding of the writing tip, and a contact conductive portion attached to the penholder and electrically connected to the conductive touch head, characterized in that: the conductive touch head has an opening, so that the writing tip is capable of being exposed in a situation that both the pen tip and the conductive touch head contact the writing surface simultaneously.

8. The touch writing pen according to claim 7, wherein the contact conductive portion includes an electrically conductive annular or tubular article, and is exposed to the outside of the penholder.

9. The touch writing pen according to claim 7, wherein the contact conductive portion is a conductive long strip or wire object with one end of the contact conductive portion being electrically connected to the conductive touch head, and the other end being housed within the penholder.

10. A wiping device capable of erasing an entity handwriting written by a touch writing pen on a writing surface with a touch input function, and an electronic handwriting corresponding to the entity handwriting, wherein the touch writing pen includes a penholder, a writing tip disposed on one end of the penholder, a conductive touch head disposed at the surrounding of the writing tip, and a contact conductive portion attached to the penholder and electrically connected to the conductive touch head, and the pen tip and the conductive touch head are capable of contacting the writing surface simultaneously, wherein the wiping device includes a main body, a conductive wiping surface disposed at one side of the main body, and a conductive element electrically connected to the wiping surface, so that the wiping surface is capable of erasing the entity handwriting and the corresponding electronic handwriting simultaneously.

11. A method for simultaneously forming an entity handwriting and a corresponding electronic handwriting, comprising steps of:
transferring via a touch writing pen a writing material to a writing surface of a touch input device to form the entity handwriting, wherein the touch writing pen includes a writing tip; and
at the same time, providing a conductive means surrounding the writing tip, and forming an electronic conductive path between the writing surface and a user's body through the conductive means in order to perform a touch input so as to form the electronic handwriting.

12. The method according to claim 11, wherein the electronic conductive path is produced by the conductive means disposed at the surrounding of the writing tip and extending to the user's body.

13. The method according to claim 11, further comprising steps of:
presetting a specific area value, so that when a conductive contact between a conductive object and the writing surface with a contact area exceeding the specific area value, determining that the conductive contact a wiping operation of an electronic handwriting;
providing a wiping device having a wiping surface larger than the specific area value and constructed by conductive material capable of erasing the entity handwriting; and
enabling the user's body and the wiping surface electrically conductive, and wiping the writing surface with the wiping surface to simultaneously erase the entity handwriting and the electronic handwriting.
